(19) United States
(12) Patent Application Publication
(10) Pub. No.: US 2004/0236144 A1
(43) Pub. Date: Nov. 25, 2004

(54) Method for producing $g(a)-aminophosphonic acids

(76) Inventors: Christian Wulff, Mannheim (DE); Stefan Orsten, Ellerstadt (DE); Alfred Oftring, Bad Durkheim (DE)

Correspondence Address: KEIL & WEINKAUF, 1350 CONNECTICUT AVENUE, N.W., WASHINGTON, DC, 20036, US

(21) Appl. No.: 10/481,576

(22) PCT Filed: Jun. 21, 2002
(86) PCT No.: PCT/EP02/06901

(30) Foreign Application Priority Data
Jun. 22, 2001 (DE) 101 30 134.0

(51) Int. Cl. C07F 9/28

(52) U.S. Cl. 562/16

(57) ABSTRACT

The present invention relates to a process for the preparation of α-aminophosphonic acids by reaction of a hexahydrotriazine derivative with a triorganyl phosphite. The process proceeds via the intermediate of a phosphono compound, which is hydrolyzed to the α-aminophosphonic acid. The invention likewise relates to the phosphono compound itself and the process for its preparation. The process according to the invention gives α-aminophosphonic acids in high yield and purity in a simple and inexpensive manner.

The invention relates to a process for the preparation of α-aminophosphonic acids by reacting specific hexahydrotriazine compounds with triorganyl phosphites, and to intermediates for use in this process.

α-Aminophosphonic acids are compounds which have great importance industrially. They are employed, for example, as agrochemicals, as described in DE 25 57139, EP 480 307, as pharmaceutical intermediates, as described in U.S. Pat. No. 5,521,179, as flame retardants, as described in DE 25 00 428, as dye intermediates, as described in EP 385 014, or as gelate-forming agents, as described in DE 25 00 428.

Numerous processes for the preparation of α-aminophosphonic acids, and in particular for the preparation of N-phosphonomethylglycine (glyphosate), a total herbicide which is employed to a great extent, are known. One possibility of preparing glyphosate consists in reacting hexahydrotriazine derivatives with phosphorous acid esters. Thus U.S. Pat. No. 4,181,800 describes the preparation of hexahydrotriazines of the formula

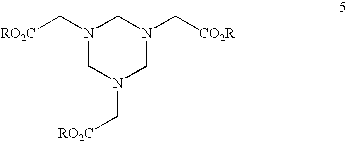

and U.S. Pat. No. 4,053,505 the reaction of these hexahydrotriazines with phosphorous acid diesters and subsequent hydrolysis of the product obtained to phosphonomethylglycine. It has been shown that both yield and selectivity in favor of the monophosphonated product are worthy of improvement. Moreover, phosphorous acid diesters are very expensive.

EP-A-104 775, U.S. Pat. Nos. 4,425,284, 4,482,504 and 4,535,181 describe the reaction of the above hexahydrotriazines with an acyl halide and the subsequent phosphonation with a phosphorous acid triester and hydrolysis to phosphonomethylglycine according to the following reaction equation:

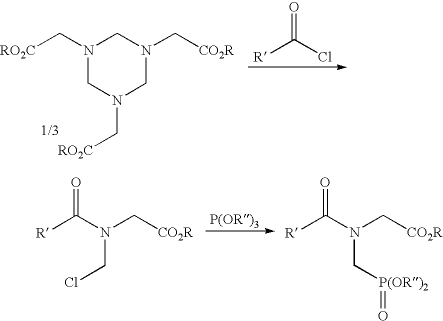

Although phosphonomethylglycine is obtained in relatively good yield in this way, the process additionally necessitates, beside the use of the expensive phosphorous acid esters, the employment of a carboxylic acid chloride. There is also the fact that the carboxylic acid chloride is in any case recovered in the form of the free acid and could then be converted into the acid chloride again in a separate step, which considerably increases the costs of the process. Further, the alcohol with which the phosphorous acid is esterified cannot be recycled completely, as in the reaction one equivalent of the corresponding alkyl chloride is formed, which is moreover questionable toxicologically.

U.S. Pat. No. 4,428,888 and EP-A-149 294 describe the reaction of the abovementioned hexatriazine with a phosphorous acid chloride in the presence of a strong anhydrous acid, for example hydrogen chloride, and a C₁-C₆-carboxylic acid, such as acetic acid. In this way, numerous undefined by-products are obtained, which allow the yield of phosphonomethylglycine and necessitate a laborious purification of the product.

U.S. Pat. No. 4,442,044 describes the reaction of a hexahydrotriazine of the formula 5 with a phosphorous acid triester to give the corresponding phosphonate compound, which is used as a herbicide.

In DD-A-141 929 and DD-A-118 435, the reaction of an alkali metal salt of the above hexahydrotriazine (R=for example Na) with a phosphorous acid diester is described. On account of the poor solubility of the alkali metal salts, however, only a small conversion is obtained.

U.S. Pat. No. 5,053,529 describes the preparation of phosphonomethylglycine by reaction of the above hexahydrotriazines with phosphorous acid triesters in the presence of titanium tetrachloride and subsequent hydrolysis of the product obtained. The use of titanium tetrachloride makes the preparation considerably more expensive. Moreover, the yields of phosphonomethylglycine are unsatisfactory.

U.S. Pat. No. 4,454,063, U.S. Pat. No. 4,487,724 and U.S. Pat. No. 4,429,124 describe the preparation of phosphonomethylglycine by reacting a compound of the formula

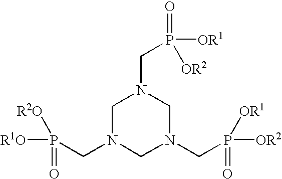

in which R¹ and R² are aromatic or aliphatic groups, with RCOX (X=Cl, Br, I) to give a compound of the formula

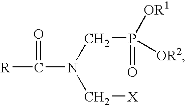

and reacting this compound with a metal cyanide and hydrolyzing the product obtained. The disadvantages of this process are as indicated above with respect to the use of the acid chloride.

Further synthesis possibilities are described starting from the cyanomethyl-substituted hexahydrotriazine of the formula

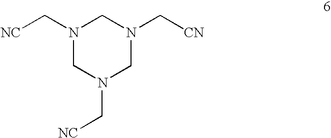

Thus U.S. Pat. No. 3,923,877 and U.S. Pat. No. 4,008,296 disclose the reaction of this hexahydrotriazine derivative with a dialkyl phosphite in the presence of an acidic catalyst, such as hydrogen chloride, a Lewis acid, a carboxylic acid chloride or anhydride, to give a compound of the formula

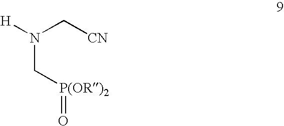

Subsequent hydrolysis affords phosphonomethylglycine, 8 to 10% of the di phosphonomethylated product resulting.

U.S. Pat. No. 4,067,719, U.S. Pat. Nos. 4,083,898, 4,089,671 and DE-A-2751631 describe the reaction of the cyanomethyl-substituted hexahydrotriazine with a diaryl phosphite without catalyst to give a compound 9 where R″=aryl. This process has the same disadvantages described above for the use of the carboxyl-substituted hexahydrotriazine 5.

EP-A-097 522 (corresponding to U.S. Pat. No. 4,476,063 and U.S. Pat. No. 4,534,902) describes the reaction of the hexahydrotriazine 6 with an acyl halide to give 10, subsequent phosphonation with a phosphorous acid triester or diester to give 11 and finally hydrolysis to phosphonomethylglycine according to the following reaction equation:

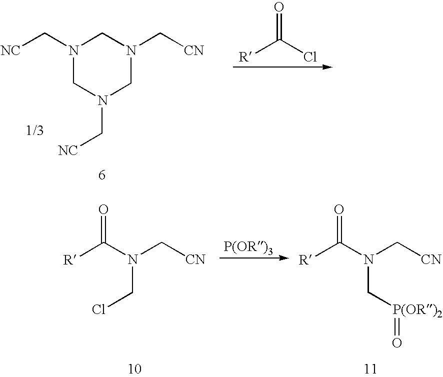

Here too, the same disadvantages are to be observed as for the processes using carboxyl-substituted hexahydrotriazine derivatives.

Finally, U.S. Pat. No. 4,415,503 describes the reaction of the cyanomethyl-substituted hexahydrotriazine analogously to the process described in U.S. Pat. No. 4,428,888. In this case too, the increased formation of by-products is to be observed.

EP 164 923 A describes an improved hydrolysis of a compound of the formula 11.

Glyphosate can also be obtained by the route via diketopiperazine. Diketopiperazine is a monoprotected glycine derivative and is thus a potential starting material which makes possible a specific simple phosphonomethylation. The synthesis route via this compound has three significant disadvantages: firstly, only phosphonomethylglycine is accessible, secondly, the synthesis of diketopiperazine is difficult and gives poor yields (Curtius et al., J. Prakt. Chem. 1988, 37, 176; Schöllkopf et al., Liebigs Ann. Chem. 1993, 715-719; DE 2934252), and moreover the phosphonomethylation of amides is generally difficult, gives poor yields and frequently requires expensive reagents (U.S. Pat. No. 4,400,330; Natchev, Synthesis, 1987, 12, 1077; Zecchini, Int. J. Pept. Prot. Res. 1989, 34, 33; Couture, Tetrahedron Lett. 1993, 34, 1479).

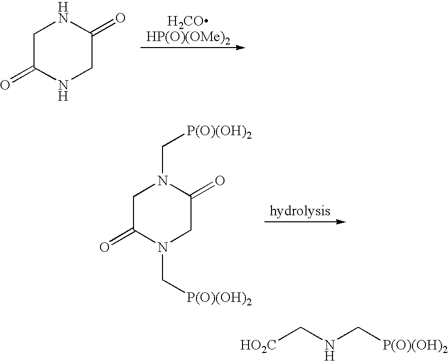

A direct selective phosphonomethylation of primary amines by way of example of glycine especially was developed in China and elaborated as far as industrial readiness there. In this process, dimethyl phosphite is reacted with formaldehyde and glycine in methanol as a solvent with addition of triethylamine. The process, however, is relatively complicated, and large amounts of triethylamine are consumed in each cycle. In comparison with the other prior art, this process is therefore not economical (Chen Xiaoxiang, Han Yimei, Ren Bufan, Xiandai Huagong 1998, 2, 17; U.S. Pat. No. 4,486,359; U.S. Pat. No. 4,237,065).

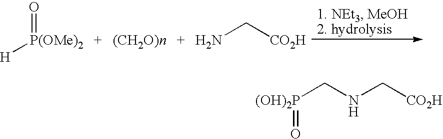

In order to force a simple phosphonomethylation, protective groups are frequently employed. Examples of the use of CO₂ (U.S. Pat. No. 4,439,373), benzyl (U.S. Pat. No. 4,921,991), carbamates (U.S. Pat. No. 4,548,760), hydroxylamines (Pastor, Tetrahedron 1992, 48 (14), 2911), silyl (Courtois, Synth. Commun. 1991, 21 (2), 201).

In principle, the use of a protective group always necessitates two additional synthesis steps, namely the introduction and the removal of the protective group, which is always disadvantageous for economic reasons, particularly if the protective group cannot be recycled.

For the synthesis of N-formylaminomethylphosphonic acid, formamide can be used as a starting material as in EP 98159, converted into the corresponding methylol using formaldehyde and then phosphonated using triethyl phosphite. As described further above, this process leads to two problems: on the one hand to the employment of expensive phosphite, on the other hand to poor yields in the phosphonomethylation of amides. An analogous reaction using benzamide is possible (U.S. Pat. No. 5,041,627, WO 92/03448). Both N-benzoyl- and N-formylaminomethylphosphonic acid can then be hydrolyzed to the free aminomethylphosphonic acid.

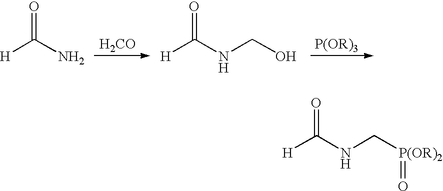

This synthesis method was extended in U.S. Pat. No. 4,830,788 to the preparation of N-substituted aminomethylphosphonic acid derivatives by employing N-substituted amides. The employment of N-alkyl-substituted N-methylol formamides is described by R. Tyka in Synthesis 1984, 218.

Likewise, N-acylaminomethylphosphonic acid derivatives are passed through in the use of hexahydrotriazines as intermediates for the aminomethylphosphonic acid synthesis. Thus N-acyltriazines can be reacted with PCl₃ in acetic acid in poor yields (Soroka, Synthesis 1989, 7, 547). Moreover, this process yields a large amount of undesired by-products such as bis(chloromethyl ether), acetyl chloride and acetic anhydride, which have to be evaporated off and, in certain circumstances, disposed of. The employment of the comparatively expensive phosphites increases the yield slightly. Good yields can be achieved if catalysts such as BF₃ are additionally used (Maier, Phosphorus, Sulfur, and Silicon 1990, 47, 361).

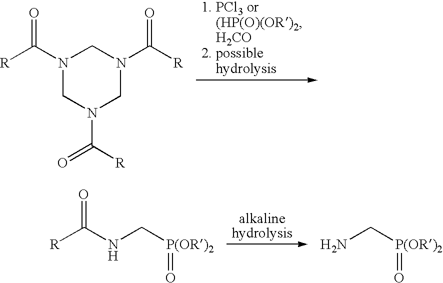

Reactions with N-alkyl triazines are a further possibility of obtaining aminophosphonic acids. These reactions have the same disadvantages as described above. Literature examples are found in Oberhauser, Tetrahedron 1996, 52 (22), 7691 for R=benzyl; Stevens, Synlett 1998, (2), 180 for R=allyl.

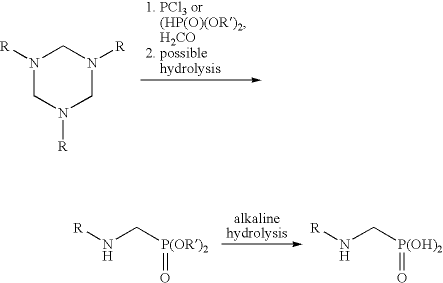

In the unpublished patent application DE 199 62 601, a process for the preparation of N-phosphonomethylglycine is described in which

a) a hexahydrotriazine derivative of the formula II

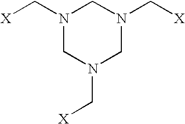

in which

X is CN, COOZ, CONR¹R² or CH₂OY,

Y is H or a radical which can easily be replaced by H;

Z is H, an alkali metal, alkaline earth metal, C₁-C₁₈-alkyl or aryl which is optionally substituted by C₁-C₄-alkyl, NO₂ or OC₁-C₄-alkyl;

R¹ and R², which can be identical or different, are H or C₁-C₄-alkyl,

is reacted with a triacyl phosphite of the formula III

P(OCOR³)₃

in which the radicals R³, which can be identical or different, are C₁-C₁₈-alkyl or aryl which is optionally substituted by C₁-C₄-alkyl, NO₂ or OC₁-C₄-alkyl,

to give a compound of the formula I

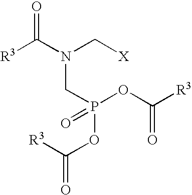

in which R³ and X have the meanings indicated above, and

b) the compound of the formula I is hydrolyzed and, if X is CH₂OY, oxidized.

Step (a) of the process is preferably carried out in an inert organic solvent. The hydrolysis of the reaction product is carried out either in an aqueous/organic two-phase system, or the solvent used in step (a) is distilled off before the hydrolysis.

The known processes for the preparation of α-aminophosphonic acids are encumbered with numerous disadvantages.

However, particularly in the case of pharmaceutical and crop protection active compounds, in the synthesis, the problem of having to introduce exactly one phosphonomethyl group into a primary nitrogen atom is frequently encountered. On the industrial scale, such syntheses should start from inexpensive starting substances and create low manufacturing costs, but yield products which are as pure as possible.

It is an object of the present invention to make available a simple and economical process for the preparation of α-aminophosphonic acids, in which the product is moreover obtained in high purity.

We have found that this object is achieved by reacting a hexahydrotriazine derivative with a triorganyl phosphite and subsequently hydrolyzing the product obtained to the α-aminophosphonic acid.

The present invention therefore relates to a process for the preparation of α-aminophosphonic acids of the formula I:

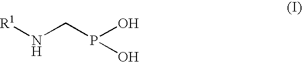

in which R¹ has the meanings indicated for R², excluding CH₂CO₂H,

where

(a) a hexahydrotriazine derivative of the formula II

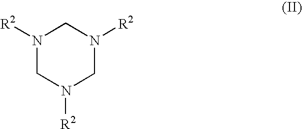

in which R² is C₁-C₂₀₀-alkyl, C₂-C₂₀₀-alkenyl, C₃-C₁₀-cycloalkyl, C₃-C₁₂-heterocyclyl, aryl, N(R⁴)₂ or OR⁴,

where each alkyl, alkenyl, cycloalkyl, heterocyclyl and aryl radical can have 1, 2, 3 or 4 substituents which independently of one another are selected from C₁-C₁₈-alkyl, C₃-C₁₀-heterocyclyl, CO₂R⁵, CO₂M, SO₃R⁵, SO₃M, HPO(OH)OR⁵, HPO(OH)OM, CN, NO₂, halogen, CONR⁶R⁷, NR⁶R⁷, alkoxyalkyl, haloalkyl, OH, OCOR⁵, NR⁶COR⁵, unsubstituted aryl and substituted aryl which has one or two substituents which independently of one another are selected from C₁-C₁₀-alkyl, alkoxy, halogen, NO₂, NH₂, OH, CO₂H, CO₂-alkyl, OCOR⁵ and NHCOR⁵,

R⁴ is hydrogen, C₁-C₂₀-alkyl, C₁-C₂₀-alkenyl, C₃-C₁₀-cycloalkyl or aryl,

R⁵ is hydrogen, C₁-C₁₈-alkyl, aryl or arylalkyl,

M is a metal cation,

R⁶ and R⁷ independently of one another are hydrogen or C₁-C₁₀-alkyl,

is reacted with a triorganyl phosphite of the formula III

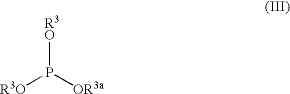

in which the radicals R³ can be identical or different, and are C₁-C₁₈-alkyl, C₅-C₆-cycloalkyl, aryl, C₁-C₁₈-acyl or arylcarbonyl or together can form a C₂-C₃-alkylene radical and R^{3a} is C₁-C₁₈-acyl or arylcarbonyl, where each aryl radical can have one or two substituents which independently of one another are selected from C₁-C₄-alkyl, NO₂ and OC₁-C₄-alkyl,

and

(b) the product obtained is hydrolyzed to the α-aminophosphonic acid of the formula I.

Alkyl is a linear or branched alkyl chain preferably having 1 to 20, in particular 1 to 8, carbon atoms. Examples of alkyl are methyl, ethyl, n-propyl, i-propyl, n-butyl, i-butyl, sec-butyl, t-butyl, n-hexyl, 2-ethylhexyl, etc.

Aryl is preferably phenyl or naphthyl.

Alkenyl is a linear or branched alkenyl chain preferably having 2 to 20 carbon atoms. Examples of alkenyl are vinyl, allyl, 1-butenyl, oleyl, etc.

Halogen is fluorine, chlorine, bromine or iodine, in particular chlorine or bromine.

Heterocyclyl is a mono- or bicyclic, heterocyclic radical having 3 to 12 ring atoms, which has 1, 2 or 3 heteroatoms which independently of one another are selected from O, S and N. The heterocyclic radical can be saturated or unsaturated, aromatic or nonaromatic. A monocyclic radical having 5 or 6 ring atoms or a bicyclic radical having 10, 11 or 12 ring atoms is preferred. Examples of heterocyclic radicals are pyrrolyl, imidazolyl, triazolyl, furyl, oxazolyl, oxadiazolyl, thienyl, thiazolyl, thiadiazolyl, pyridyl, pyrimidyl, indolyl, quinolyl, pyrrolidinyl, morpholinyl, piperidinyl, piperazinyl, tetrahydroquinolinyl, etc.

The cycloalkyl radical is preferably cyclopentyl or cyclohexyl.

The metal cation M is preferably an alkali metal cation or the equivalent of an alkaline earth metal cation, in particular sodium, potassium or calcium.

In the hexahydrotriazine derivative of the formula II, the radicals R² are preferably C₁-C₁₈-alkyl, polyisobutyl, C₁₂-C₂₀-alkenyl (derived from the corresponding unsaturated fatty acids), phenyl, benzyl and allyl. Phenyl and the phenyl radical in benzyl can be substituted as indicated above. Preferred substituents are C₁-C₁₈-alkyl, halogen, NO₂, CN, CO₂R⁵ and CO₂M.

The radical R¹ of the α-aminophosphonic acid is preferably identical to the radical R².

The triorganyl phosphites of the formula III have at least one acyl group R^{3a}. R^{3a} is C₁-C₁₈-acyl or arylcarbonyl, where each aryl radical can have one or two substituents which independently of one another are selected from C₁-C₄-alkyl, NO₂ and OC₁-C₄-alkyl. R^{3a} is preferably benzoyl or acetyl.

The radicals R³ can be identical or different and have the same meaning as R^{3a} or are C₁-C₁₈-alkyl, C₅-C₆-cycloalkyl or aryl, where the aryl radical can have one or two substituents which independently of one another are selected from C₁-C₄-alkyl, NO₂ and OC₁-C₄-alkyl. The radicals R³ can also together form C₂-C₃-alkylene.

Preferred radicals R³ are methyl, ethyl and an ethylene group formed from two radicals R³ together.

Particularly preferred compounds of the formula III are

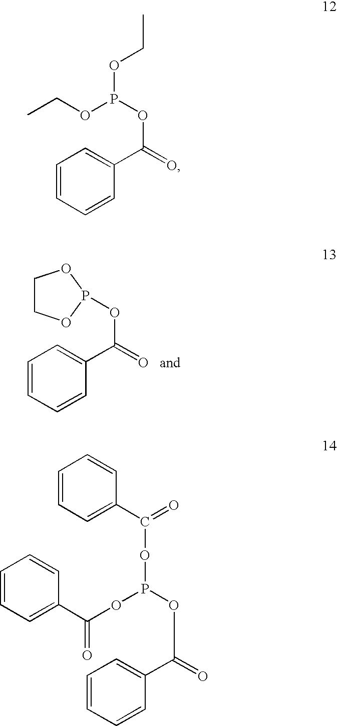

Moreover, the present invention relates to phosphono compounds of the formula IV, in which the radicals have the meanings indicated above, and their preparation as in step (a) of the process according to the invention for the preparation of α-aminophosphonic acids. The radical R^{2a}=R² and R³ has the meanings indicated for R^{3a}.

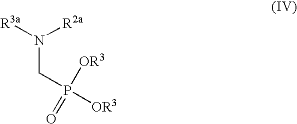

The compounds of the formula II are known and can be prepared in a known manner or analogously to known processes. For example, an amine X—CH₂—NH₂ can be reacted with a formaldehyde source, such as aqueous formalin solution or paraformaldehyde, for example by dissolving the primary amine in the aqueous formalin solution. The desired hexahydrotriazine can then be obtained by crystallization or evaporation of the water. This process is described in DE-A-2645085, to which reference is fully made hereby.

The compound of the formula II in which X is CN can be obtained by Strecker synthesis, i.e. by reaction of ammonia, hydrocyanic acid and a formaldehyde source. A process of this type is described, for example, in U.S. Pat. No. 2,823,222, to which reference is fully made hereby.

The compounds of the formula III can be prepared by a number of processes. A first possibility is the reaction of a salt of a carboxylic acid R³COOH with a phosphorus trihalide, in particular phosphorus trichloride. The carboxylic acid salt used is preferably an alkali metal or alkaline earth metal salt, in particular the sodium, potassium or calcium salt, or the ammonium salt. This reaction can be carried out without use of a solvent and the reaction product obtained employed directly in step (a). Preferably, however, it is carried out in an inert organic solvent, in particular in an ether, such as dioxane, tetrahydrofuran etc., a halogenated, in particular a chlorinated or fluorinated, organic solvent, such as dichloromethane, 1,2-dichloroethane, 1,2-dichloropropane, 1,1,1-trichloroethane, 1,1,2-trichloroethane, 1,1,2,2-tetrachloroethane, chlorobenzene or 1,2-dichlorobenzene, an aliphatic or aromatic hydrocarbon, such as n-octane, toluene, xylene, or nitrobenzene. Preferably, the same solvent is used as subsequently in step (a). The use of a chlorinated hydrocarbon is particularly preferred.

The salt formed in the reaction, for example sodium chloride when using phosphorus trichloride, and the sodium salt of the carboxylic acid employed can be removed after the reaction. If the salt obtained is ammonium chloride or another ammonium halide, the ammonia employed can be recovered by rendering an aqueous solution of the salt strongly alkaline (pH 11-14) using a strong base, for example sodium hydroxide solution and subsequently stripping off the ammonia in the customary manner. The ammonia obtained in this manner can be fed back again after drying, for example by distillation in the liquid or gaseous state, or as an aqueous solution, and used for the preparation of the ammonium salt of the carboxylic acid.

A further possibility for the preparation of the compounds of the formula III is the reaction of a carboxylic acid R³COOH with the phosphorus trihalide in the presence of an amine. Amines used are, in particular, aliphatic or cycloaliphatic di- or triamines, such as triethylamine, tributylamine, dimethylethylamine or dimethylcyclohexylamine, and also pyridine. In general, a process of this type is carried out in an organic solvent. Suitable solvents are indicated above in connection with the first preparation possibility. Preferably, the amine hydrochlorides are treated with a strong base, for example with aqueous sodium hydroxide solution, so the amines are released from the hydrochloride. Volatile amines can be recovered by distillation or extraction. Nonvolatile amines can be recovered by extraction or, if a two-phase mixture is obtained during the liberation of amine, by phase separation. Solid amines can be recovered by filtering off. The recovered amines can be fed back into the process again, optionally after drying.

A further possibility for the preparation of the compounds of the formula III is the reaction of the carboxylic acid R³COOH with a phosphorus trihalide, in particular phosphorus trichloride, without addition of a base. In this reaction, it is necessary to remove the hydrogen halide formed from the reaction mixture. This can be carried out in a customary manner, for example by passing through an inert gas, such as nitrogen. The released hydrogen halide can then be used for the hydrolysis in step (b) in the form of an aqueous solution.

In the abovementioned processes, triacyl phosphites are in each case formed. Phosphites having one or two acyl groups can be prepared analogously from (R³O)₂PCl or R³OPCl₂.

Step (a) of the process according to the invention can be carried out with or without solvent, for example in the melt. Preferably, however, an inert organic solvent is used, for example a hydrocarbon, such as toluene or xylene, an ether, such as tetrahydrofuran, dioxane or dibutyl ether, nitrobenzene etc. Particularly preferably, the reaction is carried out in a halogenated solvent, in particular a chlorinated, preferably a chlorinated and/or fluorinated, aliphatic hydrocarbon, such as dichloromethane, 1,2-dichloroethane, 1,2-dichloropropane, 1,1,1-trichloroethane, 1,1,2-trichloroethane, 1,1,2,2-tetrachloroethane, chlorobenzene or 1,2-dichlorobenzene. The reaction components are expediently employed in essentially stochiometric amounts. However, it is also possible to use an excess of, for example, up to 10% of one or the other reaction component. The reaction temperature is in general in the range from −10° C. to 140° C., preferably in the range from room temperature to 100° C. Under these conditions, only short reaction times are necessary, in general the reaction is essentially complete after 10 to 30 min.

The products obtained according to step (a) are further processed to give the α-aminophosphonic acids. For this purpose, the products are subjected to a hydrolysis. This can be carried out under acidic or alkaline conditions, preferably the hydrolysis is carried out in acidic conditions. Acids used are in particular inorganic acids, such as hydrochloric acid, sulfuric acid or phosphoric acid. The alkaline hydrolysis is in general carried out using an alkali metal or alkaline earth metal hydroxide, in particular using sodium or potassium hydroxide.

The hydrolysis is expediently carried out using an aqueous acid or base. In this process, the aqueous acid or base is in general added to the reaction mixture obtained from step (a). The hydrolysis can be carried out without solvent or in the presence of a water-miscible, partially miscible or nonmiscible, inert, organic solvent. Preferably, the solvent employed in step (a) is used. When using a solvent in step (a), expediently the reaction mixture obtained from step (a) is employed directly, optionally after removing, e.g. by distilling off, some of the solvent. Alternatively, the solvent used in step (a) is completely removed and the residue is subjected to hydrolysis. The solvent recovered from the reaction mixture can be used again in the preparation of the compounds of the formula III or in step (a).

Particularly preferably, the hydrolysis is carried out in a two-phase system (aqueous phase/organic phase). In this process, a partially water-miscible or nonmiscible organic solvent is used, preferably a hydrocarbon, such as toluene or xylene, an ether, such as dibutyl ether, and in particular a halogenated hydrocarbon such as mentioned above as a solvent for step (a). The hydrolysis is carried out with intensive mixing of the two phases using customary equipments, e.g. stirred reactors, circulating reactors or preferably static mixers. After hydrolysis is complete, the phases are separated and worked up as described below.

A particularly preferred embodiment is a process in which step (a) is carried out in a halogenated solvent, the solvent is optionally partially removed, and the compound of the formula IV obtained is subjected to hydrolysis by treating the reaction mixture obtained from stage (a) with an aqueous acid or base.

Alternatively, the hydrolysis of the compound of the formula IV can also be carried out enzymatically, e.g. using an esterase or a nitrilase.

The acid or base is used in at least equivalent amounts but preferably in an excess, in particular in an amount of ≧2 equivalents.

The temperature at which the hydrolysis is carried out is in general in the range from approximately 10° C. to 180° C., preferably 20° C. to 150° C.

The phosphono compound IV obtained in step (a) can also be extracted into an aqueous phase before the hydrolysis. This has the advantage that the cost-intensive partial or complete distilling off of the solvent used in step (a) is unnecessary. Moreover, sharper hydrolysis conditions can be chosen than is possible in the presence of an organic solvent, since no decomposition of the organic solvent is to be feared.

The hydrolysis according to step (b) of the process according to the invention is carried out in this hydrolysis variant in the following substeps:

(b1) the reaction product from step (a) is extracted from the reaction mixture of step (a) using water or an aqueous solution of an acid or base, partial hydrolysis optionally already occurring. The mixture can then be rendered alkaline, if desired, by addition of a base.

(b2)The aqueous and the organic phase are separated.

(b3)The compounds contained in the aqueous phase are reacted further, i.e. the still unhydrolyzed product from step (a) is hydrolyzed.

The hydrolysis can be carried out, as mentioned, under acidic, neutral or alkaline conditions. The pH conditions can correspond here to the desired conditions in the subsequent hydrolysis, but it is also possible to extract in a pH range other than that in which hydrolysis is subsequently carried out. For example, extraction can be carried out in the acidic or neutral range, then a base can be added and hydrolysis can be carried out in the alkaline range.

The extraction is preferably carried out at a temperature from room temperature up to the reflux temperature of the reaction mixture, particularly preferably at at least 50° C. The phase transfer of the phosphono compound into the aqueous phase proceeds very rapidly.

In general, depending on temperature, extraction times of a few minutes, e.g. from 5 min, are adequate. Preferably, the extraction time is at least 10 minutes, particularly preferably at least 1 hour. In particular in the case of extraction at low temperatures, a longer extraction time may be necessary, e.g. at least 2 hours.

During the extraction, at least some of the phosphono compound, as a rule, is already partially hydrolyzed. Partial hydrolysis is to be understood as meaning that only some of the R³ or R^{3a} radicals contained in the product of stage (a) are removed. The extent of the hydrolysis is dependent on the phosphono compound itself and the extraction conditions chosen.

Acids used in the extraction are in particular inorganic acids such as hydrochloric acid, sulfuric acid or phosphoric acid. The alkaline extraction is in general carried out using an alkali metal or alkaline earth metal hydroxide, in particular using sodium or potassium hydroxide.

Decomposition of the solvent used in step (a) basically does not take place during the extraction, even if this is a chlorinated hydrocarbon which is particularly sensitive to decomposition, such as 1,2-dichloroethane.

The aqueous phase and the organic phase are then separated from one another. An organic phase is obtained which optionally contains impurities soluble therein, which are thus removed from the valuable product in a simple manner. The aqueous phase contains the product of stage a) and optionally its partially hydrolyzed product. The phase separation is carried out in a customary manner known to the person skilled in the art. The phosphono compound or the partially hydrolyzed product situated in the aqueous phase is then hydrolyzed. Depending on the desired hydrolysis conditions, acid or base can be added to the aqueous phase. Because of the high excess of acid necessary, in the case of acidic hydrolysis, hydrolysis under neutral or alkaline conditions is preferred.

In order to achieve the desired reaction temperatures, the hydrolysis is carried out at elevated pressure. Preferably, the reaction temperature during the hydrolysis is higher than during the extraction. In general, the reaction temperature is higher by at least 20° C., in particular at least 30° C., than during the extraction. Preferred reaction temperatures are in the range between 100 and 180° C., particularly preferably between 130 and 150° C. The reaction time is preferably between approximately 5 minutes and 4 hours, particularly preferably 10 minutes to 2 hours, very particularly preferably approximately 20 minutes.

Neutral or basic conditions are preferred in the hydrolysis. When using a base, particularly preferably basically equivalent amounts are used.

Acids and bases used for the hydrolysis are in general the acids or bases indicated above in connection with the extraction.

Attention does not need to be paid to mild hydrolysis conditions, as no organic solvent which could be decomposed is present.

Subsequently, the α-aminophosphonic acid can be separated off from the aqueous phase (step b4).

Preferably, moreover after step (b4) constituents which can be fed back and/or reutilized are separated off and fed back into the process.

The α-aminophosphonic acid obtained during the hydrolysis is now found in the aqueous phase in dissolved form. The carboxylic acid R³COOH or R^{3a}COOH is formed directly during hydrolysis with an excess of acid or, in the case of base hydrolysis, after acidifying with a strong acid, preferably at a pH of <2.0. The carboxylic acid is then separated off in a customary manner, for example by filtering off the carboxylic acid precipitated in solid form, distillation or extraction with an organic solvent which is not miscible with the aqueous phase. In the case of two-phase hydrolysis, the carboxylic acid is optionally present in the organic phase in dissolved form. The carboxylic acid is then removed by separating off the organic phase and can be removed therefrom, if desired, in a customary manner. It is obtained in high purity and can be employed again for the preparation of the compound of the formula III without problems.

If alcohols are additionally liberated by the hydrolysis of the phosphono compounds IV, these are preferably present in the aqueous phase in dissolved form and can be recovered therefrom, e.g. by distillation. Optionally, they can then be fed back into the process again.

The solvent forming the organic phase can be fed back and used again in the preparation of the compound of the formula III or in step (a). Beforehand, the solvent is in general subjected, however, to a distillation, extraction, filtration and/or stripping in order to remove impurities, such as water-soluble or nonwater-soluble alcohols, phenols, ammonium salts and/or carboxylic acids.

The α-aminophosphonic acid can be precipitated by adjusting the aqueous phase to a pH which approximates or corresponds to the isoelectric point of the α-aminophosphonic acid, e.g. by addition of an acid or base, e.g. HCl, H₂SO₄ or NaOH, KOH, Ca(OH)₂ and optionally by concentrating the aqueous phase and/or by adding a precipitating aid, and recovered in a customary manner, for example by filtration. The isoelectric points of α-aminophosphonic acids in general lie at pHs in the range from 0.5 to 7.0. The precipitating aid used is preferably a water-miscible solvent, such as methanol, ethanol, isopropanol, acetone etc. The solvents can be recovered from the mother liquor by distillation and used again.

Ammonia or ammonium chloride resulting during the hydrolysis can be fed to the process again by optionally rendering the mixture alkaline and recovering the ammonia by stripping it off.

If necessary, the α-aminophosphonic acid obtained can be decolorized in a customary manner. This can be carried out, for example, by treatment with small amounts of a decolorizing agent, e.g. oxidizing agents, such as perborates or H₂O₂, or adsorbents, such as activated carbon. The amount of decolorizing agent depends on the degree of discoloration and can be determined in a simple manner by the person skilled in the art. The treatment with the decolorizing agent can be carried out in any desired place after hydrolysis and in a customary manner. Expediently, the decolorizing agent is added before precipitating the α-aminophosphonic acid.

The process according to the invention or each stage taken per se can be carried out continuously, batchwise or as a semi-batch process. Customary reaction containers are used for such purposes, such as stirred vessels or tubular reactors, extraction columns, mixer-settlers or phase separators, optionally having preconnected mixing devices or mixing elements incorporated in the tubular reactor.

The process according to the invention is thus distinguished by simple carrying out of the process and cheap substances employed. Only an inorganic chloride is obtained as waste and the protective groups, namely the radicals of the triorganyl phosphite of the formula III, can be recycled in a simple manner. The process affords α-aminophosphonic acids in very short reaction times and high yields of >90%, starting from the hexahydrotriazine of the formula II.

The following examples illustrate the invention without restricting it.

### EXAMPLE 1

0.2 mol of Na benzoate is introduced into 50 ml of 1,4-dioxane at room temperature with exclusion of moisture. 0.0667 mol of hosphorus trichloride is added dropwise thereto and the batch is stirred at 85° C. for 20 min (colorless suspension). 0.0222 mol of the hexahydrotriazine 6 is added and the batch is stirred at 85-90° C. for a further 20 min (thin suspension, readily stirrable). The dioxane is then distilled off in vacuo at 40° C. 100 ml of concentrated hydrochloric acid are added to the residue and the mixture is refluxed for 4 h. After cooling, the benzoic acid is filtered off, washed (a little cold water) and dried.

The combined filtrates are evaporated to dryness. To isolate the phosphonomethylglycine, the residue is taken up in a little water and precipitated in the cold by addition of NaOH to pH=1.5. Complete precipitation is achieved by addition of a little methanol. The phosphonomethylglycine is filtered off and dried.

Yield: 10.3 g of phosphonomethylglycine (95.3% according to HPLC), corresponding to 91% yield, based on PCl₃. A further 1.8% by weight of phosphonomethylglycine are contained in the mother liquor of the crystallization.

### EXAMPLE 2

0.2 mol of Na benzoate is introduced into 50 ml of 1,4-dioxane at room temperature with exclusion of moisture. 0.0667 mol of phosphorus trichloride is added dropwise thereto and the batch is stirred at 85° C. for 20 min (colorless suspension). The mixture is filtered with exclusion of moisture and the residue is washed with a little dioxane. 0.0222 mol of the hexahydrotriazine 6 is furthermore added to the filtrate with the exclusion of moisture and the batch is stirred at 85° C. to 90° C. for a further 20 min. The dioxane is then distilled off in vacuo at 40° C. 100 ml of concentrated hydrochloric acid are added to the residue and the mixture is refluxed for 4 h. After cooling, the precipitated benzoic acid is filtered off, washed (a little cold water) and dried.

The combined filtrates are evaporated to dryness. To isolate the phosphonomethylglycine, the residue is taken up in a little water and precipitated in the cold by addition of NaOH to pH=1.5. Complete precipitation is achieved by addition of a little methanol. The phosphonomethylglycine is filtered off and dried.

Yield: 10.5 g of phosphonomethylglycine (94.1% according to HPLC), corresponding to 93% yield, based on PCl₃. A further 1.9% by weight of phosphonomethylglycine are contained in the mother liquor of the crystallization.

### EXAMPLE 3

A solution of 0.12 mol of triacetyl phosphite in 50 ml of dioxane is added at room temperature to a solution of 0.04 mol of the hexahydrotriazine 6 in 80 ml of dioxane. The solution is stirred at 100° C. for 2 h. The solvent is then distilled off at 40° C., firstly at normal pressure, later in vacuo. 100 ml of concentrated hydrochloric acid are added to the residue and the mixture is refluxed for 4 h. The reaction mixture is evaporated to dryness. To isolate the phosphonomethylglycine, the residue is taken up in a little water and precipitated in the cold by addition of NaOH to pH=1.5. Complete precipitation is achieved by addition of a little methanol. The phosphonomethylglycine is filtered off and dried.

Yield: 15.4 g of phosphonomethylglycine (98.7% according to HPLC), corresponding to 76% yield, based on PCl₃. A further 1.6% by weight of phosphonomethylglycine are contained in the mother liquor of the crystallization

### EXAMPLE 4

284 g of ammonium benzoate in 1000 ml of 1,2-dichloroethane are introduced into a 21 stirring flask with a Teflon blade stirrer and reflux condenser and 91.5 g of phosphorus trichloride are added dropwise under a nitrogen atmosphere in the course of 30 min. The temperature rises in the course of this to a maximum of 36° C. The mixture is then stirred at 25 to 36° C. for a further 30 min. The batch is filtered through a pressure suction filter and the filter cake is washed under nitrogen a further two times with 500 g of dichloroethane each time (2054 g of filtrate).

The filtrate is introduced at room temperature into a 2 1 stirred flask with a Teflon blade stirrer and reflux condenser and the hexahydrotriazine 6 (45.54 g) is added. The mixture is heated to 80° C. with stirring in the course of 30 min and stirred at 80° C. for 30 min. The solution is allowed to cool and hydrolyzed directly following this.

To this end, the substances employed are metered at 130° C. and 8 bar into a tubular reactor (volume about 600 ml) having a preconnected static mixer (1265 g/h of the dichloroethane solution from the preceding stage, 207 g/h of 20% strength HCl). The residence time is 30 min. A forerun is discarded. For further processing, the two-phase mixture obtained is collected during the course of 60 min. The phases are separated at 60° C. and the aqueous phase is extracted twice using 100 g of dichloroethane each time.

In a round-bottomed flask with a Teflon blade stirrer, the dichloroethane still contained in the aqueous phase is first stripped at 60° C. by passing in nitrogen for one hour. The pH is then adjusted to pH=1.0 at 40 to 60° C. in the course of 15 min using a 50% strength sodium hydroxide solution. The resulting suspension is stirred at 40° C. for a further 3 h, allowed to cool to room temperature, and the precipitated product is filter and subsequently washed with 150 g of ice water. The solid obtained is dried at 70° C. and 50 mbar for 16 h.

Yield: 54.6 g of phosphonomethylglycine (96.2% according to HPLC), corresponding to 80% yield, based on PCl₃. A further 2.1% by weight of phosphonomethylglycine are contained in the mother liquor of the crystallization.

### EXAMPLE 5

A saturated solution in water is prepared from the ammonium chloride residue of the tribenzoyl phosphite synthesis as in Example 4. This is combined with the mother liquor from the crystallization of the phosphonomethylglycine as in Example 4 and adjusted to pH 14 using excess sodium hydroxide solution. Ammonia is then stripped from the reaction mixture using nitrogen and collected for gas analysis by means of GC (purity 99%). The combined dichloroethane phases from the hydrolysis are dried by distilling off the azeotrope dichloroethane/water. Dry ammonia is passed into the dichloroethane until conversion of the benzoic acid to ammonium benzoate is complete, and the resulting suspension of ammonium benzoate in 1,2-dichloroethane is employed again in the synthesis.

Yield (first recycling): 54.0 g of phosphonomethylglycine (purity 97.0% according to HPLC) corresponds to 79% yield based on PCl₃.

Yield (second recycling): 55.1 g of phosphonomethylglycine (purity 95.5% according to HPLC) corresponds to 81% yield based on PCl₃.

### EXAMPLE 6

The reaction is carried out as described in Example 4. Instead of the solvent 1,2-dichloroethane, however, nitrobenzene is used.

Yield: 56.2 g of phosphonomethylglycine (97.4% according to HPLC), corresponding to 82% yield, based on PCl₃. A further 2.0% by weight of phosphonomethylglycine are contained in the mother liquor of the crystallization.

### EXAMPLE 7

The reaction is carried out as described in Example 4. Instead of the solvent 1,2-dichloroethane, however, 1,2-dichloropropane is used.

Yield: 54.0 g of phosphonomethylglycine (96.92% according to HPLC), corresponding to 79% yield, based on PCl₃. A further 2.1% by weight of phosphonomethylglycine are contained in the mother liquor of the crystallization.

### EXAMPLE 8

The reaction is carried out as described in Example 1, but 1,2-dichloroethane is used as a solvent instead of dioxane. 75% yield of phosphonomethylglycine is obtained.

### EXAMPLE 9

The reaction is carried out as described in Example 1, but toluene is used as a solvent instead of dioxane. 68% yield of phosphonomethylglycine is obtained.

### EXAMPLE 10

Preparation of the Phosphite from Carboxylic Acid, Amine and PCl₃

0.05 mol of phosphorus trichloride in 15 ml of toluene is added dropwise at 0° C. to a solution of 0.15 mol of benzoic acid and 0.15 mol of dimethylcyclohexylamine in 90 ml of toluene. The mixture is stirred at 0° C. for 15 min and then allowed to warm to room temperature. The precipitated hydrochloride is filtered off through a pressure suction filter with exclusion of moisture. The tribenzoyl phosphite is characterized by means of an analysis of the filtrate by ¹H-NMR and ³¹P-NMR (yield: 99%). If the residue is added to 0.15 mol of 10% strength NaOH, dimethycyclohexylamine can be recovered quantitatively by phase separation and subsequent extraction with toluene. The solution is then dried by removing the water in a separator and can be used again.

### EXAMPLE 11

0.2 mol of Na benzoate is introduced into 50 ml of 1,4-dioxane at room temperature with exclusion of moisture. 0.0667 mol of phosphorus trichloride is added dropwise thereto and the batch is stirred at 85° C. for 20 min (colorless suspension). 0.0222 mol of the hexahydrotriazine 6 (X=CN) is added and the batch is stirred at 85 to 90° C. for a further 20 min (thin suspension, readily stirrable). The dioxane is then distilled off in vacuo at 40° C. 100 ml of concentrated hydrochloric acid are added to the residue and the mixture is refluxed for 4 h. After cooling, the benzoic acid is filtered off and washed (a little cold water). The combined filtrates are extracted twice with 30 ml of toluene each time, concentrated to dryness in a rotary evaporator and concentrated in a rotary evaporator a further three times with ethanol to remove excess hydrochloric acid. The toluene phase is concentrated and the residue is combined with the recovered benzoic acid.

To isolate the phosphonomethylglycine from the residue of the aqueous phase, it can now be taken up in a little water and the mixture precipitated in the cold at pH 1.0 (addition of NaOH). Complete precipitation is achieved by addition of a little methanol, which is recovered from the mother liquor by distillation. Yield: 91%.

The recovered benzoic acid (0.2 mol, purity >99% according to HPLC) is dissolved in 0.2 mol of 5% strength NaOH and the water is then distilled off and the residue is dried. The sodium benzoate thus obtained is employed in the synthesis again together with the recovered dioxane.

Yield (first recycling): 90%

Yield (second recycling): 84%

Yield (third recycling): 88%.

### EXAMPLE 12

### Synthesis of Phosphonomethylglycine

142 g of ammonium benzoate were introduced into 500 ml of 1,2-dichloroethane at room temperature with exclusion of moisture. 45.8 g of phosphorus trichloride were added dropwise thereto and the batch was stirred at room temperature for 30 min at low stirrer speed. It was filtered with exclusion of moisture through a pressure suction filter and the residue was washed twice with 100 ml of 1,2-dichloroethane each time. Final weight: 845 g of solution. The solution was analyzed for benzoic acid by quantitative HPLC. Yield: 0.296 mol of tribenzoyl phosphite (88%).

20.1 g of the hexahydrotriazine 2 (R²=CH₂CN) were furthermore added to the filtrate with exclusion of moisture and the batch was stirred at 80° C. to 85° C. for a further 30 min. Final weight: 861 g of solution.

600 g of this solution were added together with 115 g of 20% HCl to a pressure autoclave and the temperature was controlled with vigorous stirring according to the temperature profile indicated below.

### 10 cm Platz für Figur

Temperature (° C.)

Time (min)

After the batch had cooled to <70° C., the reaction mixture was poured out of the reactor, the phases were separated at 65° C. and the phosphonomethylglycine contained in the aqueous phase was determined by quantitative HPLC and quantitative ¹H-NMR analysis.

Crude yield: 72%.

The aqueous phase was adjusted to pH=1.0 at 40° C. using sodium hydroxide solution and stirred at this temperature for 3 h. The precipitated phosphonomethylglycine was filtered off with suction, washed with a little water and dried.

Isolated yield: 70%.

### EXAMPLE 13

Synthesis of Phosphonomethylglycine

The synthesis was carried out as in Example 12. Diverging from this, the temperature was kept at 130° C. for 10 min.

Crude yield: 74%

Isolated yield: 72%

### EXAMPLE 14

Synthesis of Phosphonomethylglycine

The synthesis was carried out as in Example 12. Diverging from this, the temperature was kept at 130° C. for 20 min.

Crude yield: 73%

Isolated yield: 70%

### EXAMPLE 15

Synthesis of N-ethylaminomethylphosphonic Acid

The synthesis was carried out as in Example 13. Diverging from this, the hexahydrotriazine II (R²=ethyl) was used. To isolate the product, the mixture was adjusted to pH=2.0 using sodium hydroxide solution, the aqueous phase was concentrated to dryness in a rotary evaporator and the residue was washed with a little water.

Crude yield: 69%

Isolated yield: 53%

### EXAMPLE 16

Synthesis of N-allylaminomethylphosphonic Acid

The synthesis was carried out as in Example 15. Diverging from this, the hexahydrotriazine II (R²=allyl) was used.

Crude yield: 11% (70% yield of bis-phosphonomethylallylamine)

### EXAMPLE 17

Synthesis of Aminomethylphosphonic Acid

The synthesis was carried out as in Example 15. Diverging from this, the hexahydrotriazine II (R²=benzoyl) was used.

Crude yield: 80%

Isolated yield: 72%

### EXAMPLE 18

Synthesis of N-stearylaminomethylphosphonic Acid

The synthesis was carried out as in Example 15. Diverging from this, the hexahydrotriazine II (R²═C₁₈H₃₇) was used. To isolate the product, the reaction mixture was extracted with hexane and the hexane phase was concentrated. The residue was boiled three times with acetonitrile and then filtered until it was free of benzoic acid.

Yield: 67% of a mixture, which essentially contains N-stearylaminomethylphosphonic acid in addition to stearylamine and the di phosphonomethylated product.

### EXAMPLE 19

Synthesis of N-dodecylaminomethylphosphonic Acid

The synthesis was carried out as in Example 18. Diverging from this, the hexahydrotriazine II (R²═C₁₂H₂₅) was used. To isolate the product, the reaction mixture was extracted with hexane and the hexane phase was concentrated. The residue was boiled three times with acetonitrile and then filtered until it was free of benzoic acid.

Yield: 78% of a mixture, which essentially contains N-dodecylaminomethylphosphonic acid in addition to dodecylamine and the di phosphonomethylated product.

### EXAMPLE 20

Synthesis of N-polyisobutylaminomethylphosphonic Acid

The synthesis was carried out as in Example 18. Diverging from this, the hexahydrotriazine II (R²=polyisobutyl, M=1000) was used. To isolate the product, the reaction mixture was extracted with hexane and the hexane phase was concentrated. The residue was boiled three times with acetonitrile and then filtered until it was free of benzoic acid.

Yield: 73% of a mixture, which essentially contains N-polyisobutylaminomethylphosphonic acid in addition to polyisobutylamine and the di phosphonomethylated product.

### EXAMPLE 21

Synthesis of N-ethylaminomethylphosphonic Acid

The synthesis was carried out as in Example 15. Diverging from this, 2-furancarboxylic acid ammonium salt was used instead of ammonium benzoate.

Crude yield: 64%

Isolated yield: 61%

### EXAMPLE 22

Synthesis of N-ethylaminomethylphosphonic Acid

The synthesis was carried out as in Example 15. Diverging from this, 4-pyridincarboxylic acid ammonium salt was used instead of ammonium benzoate.

Crude yield: 73%

Isolated yield: 49%

### EXAMPLE 23

Synthesis of N-ethylaminomethylphosphonic Acid, Via Compound 12

The synthesis was carried out as in Example 15. Diverging from this, diethylchlorophosphite was used instead of PCl₃ and only 50 g of ammonium benzoate.

Crude yield: 71%

Isolated yield: 56%

### EXAMPLE 24

Synthesis of N-ethylaminomethylphosphonic Acid, Via Compound 13

The synthesis was carried out as in Example 15. Diverging from this, 2-chloro-1,3-dioxa-2-phospholane was used instead of PCl₃ and only 50 g of ammonium benzoate.

Crude yield: 63%

### EXAMPLE 25

Synthesis of 2-acetyl-1,3-dioxa-2-phospholane as a Solution in Diethyl Ether, Via Compound 13 with an Acetyl Instead of Benzoyl Radical

16.4 g of sodium acetate were introduced into 100 ml of anhydrous diethyl ether and a solution of 25.3 g of 2-chloro-1,3-dioxa-2-phospholane in 50 ml of diethyl ether was added dropwise at room temperature. The mixture was stirred overnight with exclusion of air and moisture and then filtered with exclusion of air. According to quantitative NMR analysis, the filtrate contains a solution of 1 mol of phospholane per 224 g of solution.

### EXAMPLE 26

Synthesis of 2-acetyl-1,3-dioxa-2-phospholane as a Solution in Dioxane, Via Compound 13 with an Acetyl Instead of Benzoyl Radical

54.1 g of sodium acetate were introduced into 300 ml of anhydrous dioxane and a solution of 75.9 g of 2-chloro-1,3-dioxa-2-phospholane in 100 ml of dioxane was added dropwise at room temperature. The mixture was stirred overnight with exclusion of air and moisture and then filtered with exclusion of air. According to quantitative NMR analysis, the filtrate contains a solution of 1 mol of phospholane per 926 g of solution.

### EXAMPLE 27

Synthesis of Acetoxydiethoxy Phosphite as a Solution in Diethyl Ether, Via Compound 12 with an Acetyl Instead of Benzoyl Radical

12.3 g of sodium acetate were introduced into 100 ml of anhydrous diethyl ether and a solution of 23.5 g of diethyl chlorophosphite in 50 ml of diethyl ether was added dropwise at room temperature. The mixture was stirred overnight with exclusion of air and moisture and then filtered with exclusion of air. According to quantitative NMR analysis, the filtrate contains a solution of 1 mol of phosphite per 254 g of solution.

### EXAMPLE 28

Synthesis of N-phosphonomethylglycine

8.2 g (0.04 mol) of the hexahydrotriazine II (R²═CH₂CN) were introduced at room temperature into 80 ml of anhydrous dioxane with exclusion of air and treated with a solution of 111.1 g (0.12 mol) of 2-acetyl-1,3-dioxa-2-phospholane in diethyl ether. After the initial weakly exothermic reaction, the mixture was heated at 50° C. for 60 min and at 100° C. for 90 min. The volatile components were removed and the residue was treated with 150 ml of concentrated hydrochloric acid, stirred at reflux for 4 h and concentrated to dryness. Quantitative analysis of the residue showed a crude yield of 58% of N-phosphonomethylglycine.

### EXAMPLE 29

Synthesis of N-phosphonomethylglycine

The synthesis was carried out as in Example 28 using a solution of the phosphite in dioxane.

The crude yield was 67%.

### EXAMPLE 30

Synthesis of N-phosphonomethylglycine

4.1 g (0.02 mol) of the hexahydrotriazine II (R²═CH₂CN) were introduced at 5° C. into 100 ml of anhydrous dioxane with exclusion of air and treated with a solution of 15.2 g (0.06 mol) of acetyl diethyl phosphite in diethyl ether. After the initial weakly exothermic reaction, the mixture was heated at 50° C. for 60 min and at 90° C. for 60 min. The volatile components were removed and the residue was treated with 100 ml of concentrated hydrochloric acid, stirred at reflux for 4 h and concentrated to dryness.

Quantitative analysis of the residue showed a crude yield of 52% of N-phosphonomethylglycine.

### EXAMPLE 31

Synthesis of N-hydroxyaminomethylphosphonic Acid

The synthesis was carried out as in Example 15. Diverging from this, a suspension of formaldoxime trimer hydrochloride (II where R²═OH) with one equivalent of triethylamine in dichloromethane was used.

Crude yield: 43%.

259/ew

We claim:

1. A process for the preparation of α-aminophosphonic acids of the formula I: 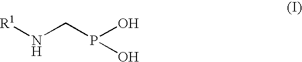
in which R¹ has the meanings indicated for R², excluding CH₂CO₂H,
where
(a) a hexahydrotriazine derivative of the formula II 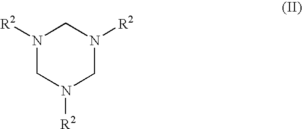
in which R² is C₁-C₂₀₀-alkyl, C₂-C₂₀₀-alkenyl, C₃-C₁₀-cycloalkyl, C₃-C₁₂-heterocyclyl, aryl, N(R⁴)₂ or OR⁴,
where each alkyl, alkenyl, cycloalkyl, heterocyclyl and aryl radical can have 1, 2, 3 or 4 substituents which independently of one another are selected from C₁-C₁₈-alkyl, C₃-C₁₀-heterocyclyl, CO₂R⁵, CO₂M, SO₃R⁵, SO₃M, HPO(OH)OR⁵, HPO(OH)OM, CN, NO₂, halogen, CONR⁶R⁷, NR⁶R⁷, alkoxyalkyl, haloalkyl, OH, OCOR⁵, NR⁶COR⁵, unsubstituted aryl and substituted aryl which has one or two substituents which independently of one another are selected from C₁-C₁₀-alkyl, alkoxy, halogen, NO₂, NH₂, OH, CO₂H, CO₂-alkyl, OCOR⁵ and NHCOR⁵,
R⁴ is hydrogen, C₁-C₂₀-alkyl, C₁-C₂₀-alkenyl, C₃-C₁₀-cycloalkyl or aryl,
R⁵ is hydrogen, C₁-C₁₈-alkyl, aryl or arylalkyl,
M is a metal cation,
R⁶ and R⁷ independently of one another are hydrogen or C₁-C₁₀-alkyl,
is reacted with a triorganyl phosphite of the formula III 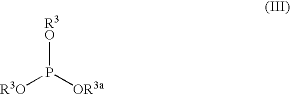
in which the radicals R³ can be identical or different, and are C₁-C₁₈-alkyl, C₅-C₆-Cycloalkyl, aryl, C₁-C₁₈-acyl or arylcarbonyl or together can form a C₂-C₃-alkylene radical and R^{3a} is C₁-C₁₈-acyl or arylcarbonyl, where each aryl radical can have one or two substituents which independently of one another are selected from C₁-C₄-alkyl, NO₂ and OC₁-C₄-alkyl, and
(b) the product obtained is hydrolyzed to the α-aminophosphonic acid of the formula I.

2. A process as claimed in claim 1, in which, by reacting the hexahydrotriazine derivative of the formula II with the triorganyl phosphite of the formula III, a compound of the formula IV 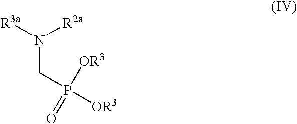
in which R³ and R^{3a} have the meanings indicated in claim 1 and R^{2a} has the meaning indicated for R² in claim 1 is obtained.

3. A process as claimed in claim 1 or 2, in which R² is C₁-C₁₈-alkyl, polyisobutyl, C₁₂-C₂₀-alkenyl, phenyl, benzyl or allyl.

4. A process as claimed in any of claims 1 to 3, in which the radicals R³ and R^{3a} independently of one another are benzoyl which is optionally substituted on the aromatic ring by C₁-C₄-alkyl, NO₂ or OC₁-C₄-alkyl, or are acyl or only the radical R^{3a} has this meaning and the radicals R³ are methyl or ethyl or together form ethylene.

5. A process as claimed in any of claims 1 to 4, in which step (a) is carried out in an organic solvent.

6. A process as claimed in claim 5, in which the solvent used is dioxane or tetrahydrofuran.

7. A process as claimed in claim 5, in which a chlorinated organic solvent, preferably 1,2-dichloroethane, is used.

8. A process as claimed in any of claims 1 to 7, in which the compounds of the formulae II and III are employed in essentially equivalent amounts.

9. A process as claimed in any of claims 1 to 8, in which the compound of the formula III is prepared by reaction of a carboxylic acid of the formula V
R³COOH (V),
in which R³ is C₁-C₁₈-alkyl, C₅-C₆-cycloalkyl or aryl, where the aryl radical can have 1 or 2 substituents which independently of one another are selected from C₁-C₄-alkyl, NO₂ and OC₁-C₄-alkyl,
or by reaction of a salt of the carboxylic acid of the formula V with a phosphorus monohalide, phosphorus dihalide or phosphorus trihalide.

10. A process as claimed in claim 9, in which the reaction is carried out in an inert organic solvent which is selected from aromatic or aliphatic hydrocarbons and chlorinated hydrocarbons, where the solvent is optionally recovered after the reaction and recycled.

11. A process as claimed in any of claims 1 to 10, in which the reaction product from step (a) is hydrolyzed using an aqueous acid.

12. A process as claimed in claim 11, in which the α-aminophosphonic acid is precipitated from the aqueous phase by adjusting the pH to a value which approximates to the isoelectric point of the α-aminophosphonic acid, preferably 0.5 to 7.0.

13. A process as claimed in claim 12, in which the precipitation of the α-aminophosphonic acid is carried out in the presence of a water-miscible solvent.

14. A process as claimed in claim 11, in which the hydrolysis is carried out in a two-phase system.

15. A process as claimed in one of claims 1 to 13, in which the hydrolysis is carried out as in step (b) by
b1) extracting the product obtained in step (a), if appropriate with partial hydrolysis, with water or an aqueous solution of an acid or an aqueous solution of a base,
b2) separating the phases and
b3) hydrolyzing or further hydrolyzing the product from step (a) contained in the aqueous phase.

16. A process as claimed in claim 15, in which, after step (b3), the α-aminophosphonic acid obtained from the aqueous phase is separated.

17. A phosphono compound of the formula IV 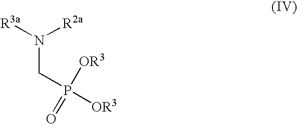
in which the radicals R³ and R^{3a} can be identical or different and are C₁-C₁₈-acyl or arylcarbonyl, where each aryl radical can have one or two substituents which independently of one another are selected from C₁-C₄-alkyl, NO₂ and OC₁-C₄-alkyl,
R^{2a} is C₁-C₂₀₀-alkyl, C₂-C₂₀₀-alkenyl, C₃-C₁₀-cycloalkyl, C₃-C₁₀-heterocyclyl, aryl or OR⁴,
where each alkyl, alkenyl, cycloalkyl, heterocyclyl and aryl radical can have 1, 2, 3 or 4 substituents which independently of one another are selected from C₁-C₁₈-alkyl, C₃-C₁₀-heterocyclyl, CO₂R⁵, CO₂M, SO₃R⁵, SO₃M, HPO(OH)OR⁵, HPO(OH)OM, CN, NO₂, halogen, CONR⁶R⁷, NR⁶R⁷, alkoxyalkyl, haloalkyl, unsubstituted aryl and substituted aryl which has 1 or 2 substituents which independently of one another are selected from C₁-C₁₀-alkyl, alkoxy, halogen, NO₂, NH₂, OH, CO₂H and CO₂-alkyl,
R⁴ is hydrogen, C₁-C₂₀-alkyl, C₁-C₂₀-alkenyl, C₃-C₁₀-cycloalkyl or aryl,
R⁵ is hydrogen, C₁-C₁₈-alkyl, aryl or arylalkyl,
M is an equivalent of a metal cation,
R⁶ and R⁷ independently of one another are hydrogen or C₁-C₁₀-alkyl,
or R^{2a} is a group which is produced from the groups indicated above by acylation, with the proviso that if all radicals R³ and R^{3a} are acyl or arylcarbonyl groups,
R^{2a} is not CH₂CN, CH₂COOZ or CH₂CONR¹¹R¹²
where Z is hydrogen, C₁-C₁₈-alkyl, aryl which is optionally substituted by C₁-C₄-alkyl, NO₂ or OC₁-C₄-alkyl, alkali metal or alkaline earth metal,
and where R¹¹, R¹² are hydrogen or C₁-C₄-alkyl.

18. A compound as claimed in claim 17, in which the radicals R³ and R^{3a} independently of one another are benzoyl which is optionally substituted by C₁-C₄-alkyl, NO₂ or OC₁-C₄-alkyl, or are acetyl.

19. A compound as claimed in claim 17 or 18, in which R^{2a} is C₁-C₁₈-alkyl, polyisobutyl, C₁₂-C₂₀-alkenyl, phenyl, benzyl or allyl.
